(19) United States
(12) Patent Application Publication
(10) Pub. No.: US 2006/0204123 A1
(43) Pub. Date: Sep. 14, 2006

(54) System and method for sharpness filter for picture-smoothing architectures

(75) Inventors: Jeffrey M. Kempf, Dallas, TX (US); David C. Hutchison, Plano, TX (US); Arnold P. Skoog, Frisco, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/071,689

(22) Filed: Mar. 3, 2005

(51) Int. Cl. G06K 9/40

(52) U.S. Cl. 382/263; 382/260

(57) ABSTRACT

According to teachings of the present invention, a system and method for a sharpness filter for picture-smoothing architectures are provided. In one embodiment, the method includes applying a finite impulse response filter to a brightness channel of an image prior to applying a picture-smoothing algorithm to the image, determining a local variance estimate for the image, and varying a gain of the finite impulse response filter based upon the local variance estimate, wherein the finite impulse response filter is an inverse of a filter that approximates the picture-smoothing algorithm.

### TECHNICAL FIELD

This invention relates generally to image processing, and more particularly to a system and method for a sharpness filter for picture-smoothing architectures.

### BACKGROUND

Digital micro-mirror devices (“DMDs”) are semiconductor devices that may be used in a variety of optical communication and/or projection display system. Generally, DMDs involve an array of micro-mirrors that selectively communicate at least a portion of an optical signal or light beam by pivoting between active “on” and “off” states. In some DMDs, these micro-mirrors are arranged in a diamond formation. A picture-smoothing algorithm, such as Texas Instruments' SmoothPicture™ technology, may be used to move the DMD array back and forth one-half pixel in the plane of the array. When done at a sufficient rate, this back and forth movement has the effect of doubling the number of addressable pixels in the DMD array. Such an approach may also be useful with other types of display technologies, such as LCD and spatial light modulators, among others. The vertical movement also has the effect of blurring pixel gaps which reduces or eliminates occurrences of what is known as the “screen door” effect, when the control electronics beneath the micro-mirrors are visible between pixels. One of the undesirable side effects of using these picture-smoothing techniques, however, is that the same blurring effect that eliminates the pixel gaps also gives the picture a soft appearance in scenes with high spatial frequency content. Attempts have been made at using convention sharpness filters to reduce this blurring effect. However, many conventional sharpness filters tend to emphasize noise and may result in oscillations, known as “ringing” artifacts, near high-frequency image structures.

### SUMMARY OF THE INVENTION

In accordance with the teachings of the present invention, a system and method for a sharpness filter for picture-smoothing architectures are provided. In one embodiment, the method includes applying a finite impulse response filter to a brightness channel of an image prior to applying a picture-smoothing algorithm to the image, determining a local variance estimate for the image, and varying a gain of the finite impulse response filter based upon the local variance estimate, wherein the finite impulse response filter is an inverse of a filter that approximates the picture-smoothing algorithm.

A technical advantage of some embodiments of the present invention may include the ability to minimize the blurring associated with picture-smoothing architectures while mitigating the emphasis of noise and/or ringing effects compared to many conventional sharpening techniques. Another technical advantage of some embodiments of the present invention may include the ability to increase the sharpness of an image by only adjusting the brightness channel of the image. Because only the brightness channel is altered, particular embodiments of the present invention may be more economical to implement than other alternatives.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of embodiments of the present invention and features and advantages thereof, reference is now made to the following description, taken in conjunction with the accompanying drawings, in which:

FIG. 1 illustrates a high-level block diagram of a sharpness enhancement system in accordance with a particular embodiment of the present invention;

FIG. 2 illustrates a block diagram of a sharpness filter in accordance with a particular embodiment of the present invention; and

FIG. 3 illustrates a block diagram of a finite impulse response filter in accordance with a particular embodiment of the present invention.

### DESCRIPTION OF EXAMPLE EMBODIMENTS

In accordance with the teachings of the present invention, a system and method for a sharpness filter for picture-smoothing architectures are provided. Generally, the sharpness filter minimizes the blurring effect of the picture-smoothing algorithm by applying an inverse transfer function to the incoming image prior to the application of the smoothing process. Particular embodiments of the present invention may be useful in a variety of display and projection systems. In particular, some embodiments of the present invention may be useful in DMD devices employing picture-smoothing techniques such as Texas Instruments' SmoothPicture™ technology.

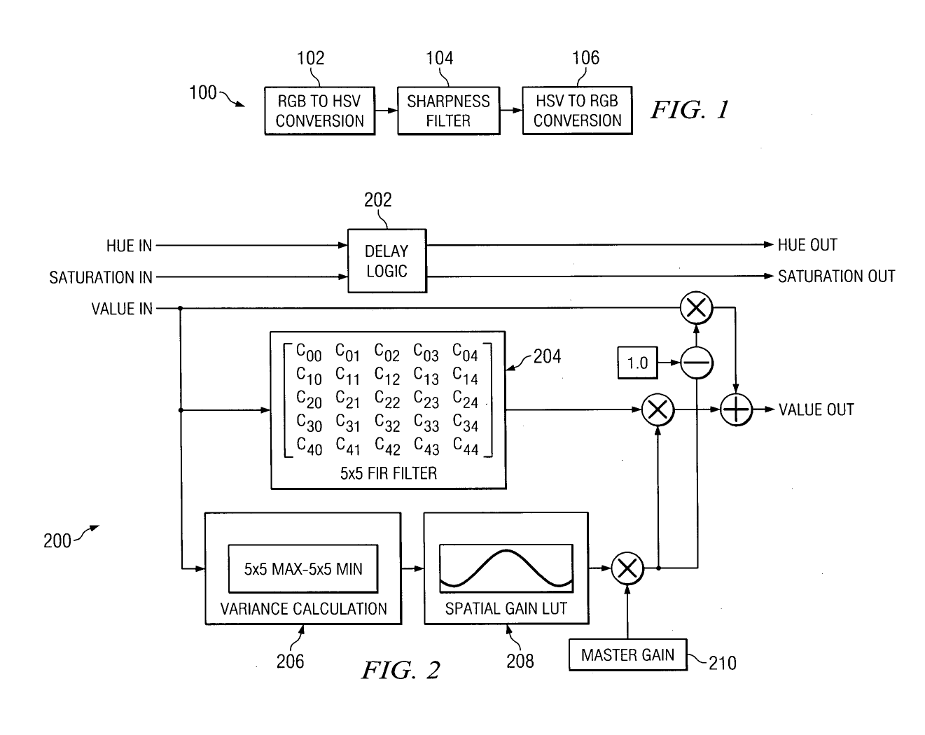

FIG. 1 illustrates high-level block diagram 100 of one embodiment of the sharpness enhancement system of the present invention. Generally, in one embodiment, the image enhancement of the present invention is performed in the Hue-Saturation-Value (“HSV”) color space, in which hue defines a particular color (such as red, magenta, or yellow), saturation defines the vibrancy of the color, and value defines the brightness of the color. Although other color spaces may also be used in accordance with the teachings of the present invention, the inverse transfer functions of the present invention need only be applied to the brightness channel of the image. By implementing the present invention in a brightness color space, such as HSV, only one channel needs to be processed, rather than three or more. Because of this, the teachings of the present invention should be easier and cheaper to implement in a brightness color space. Additionally, the human eye is more perceptive to transitions in brightness as opposed to color signals, making a brightness color space even more desirable.

Therefore, in block 102 of FIG. 1, if the input image is not in HSV, particular embodiments of the present invention first convert the image into HSV. Generally, this conversion from a non-HSV color space into HSV may be performed using a variety of known methods which would be known to one of ordinary skill in the art. For the transition from Red-Green-Blue (“RGB”), a common format for displays, to HSV, this conversion is a non-linear process, defined by the following equations:
V=maximum(R,G,B)
Delta=V−minimum(R,G,B)

If (V≠0)
S=Delta/V

Else
S=0

End

If (Delta≠0)
If (R=V)
   H=(G−B)/Delta
Else If (G=V)
   H=(B−R)/Delta+2
Else
   H=(R−G)/Delta +4
End

Else
H=0

End

Once the input image is converted in HSV format, the sharpness filter of the present invention is applied to the image in block 104. Generally, this entails applying a finite impulse response (“FIR”) filter to the brightness channel of the image, wherein the FIR filter is the inverse of a filter that approximates the picture-smoothing algorithm In particular embodiments, the gain of this filter may be adjusted based on the local variance of the image, so that noise is reduced and ringing artifacts are mitigated. Additionally, particular embodiments of the present invention may also allow for a user-definable gain value that may be used to further adjust the gain of the sharpness filter.

Once the sharpness filter of the present invention has been applied, the enhanced image may be converted back to its native, non-HSV color space in block 106. Similar to the conversion from a non-HSV color space into HSV, this may be performed using a variety of known techniques. For particular embodiments where the non-HSV format is RGB, one method of converting from HSV to RGB is defined by the following equations.
I=floor(H)
F=H−I
P=V*(1−S)
Q=V*(1−S*F)
T=V*(1−S*(1−F))

If (I=0)
R=V
G=T
B=P

Else If (I=1)
R=Q
G=V
B=P

Else If(=2)
R=P
G=V
B=T

Else If(=3)
R=P
G=Q
B=V

Else If(=4)
R=T
G=P
B=V

Else
R=V
G=P
B=Q

End

A better understanding of the sharpness filter of the present invention may be had by referring to FIG. 2, which illustrates block diagram 200 of a sharpness filter in accordance with the present invention.

As mentioned above, the FIR filter of the present invention is an inverse of a filter that approximates the picture-smoothing algorithm that will be applied to the image after the sharpness enhancement. For example, Texas Instruments' SmoothPicture™ algorithm may be approximated using the following filter.

$$H ( z ) = [ \begin{matrix}0.000 & 0.125 & 0.000 \\ 0.125 & 0.500 & 0.125 \\ 0.000 & 0.125 & 0.000\end{matrix} ]$$

In this example, H(z), is essentially a blurring function, where the coefficients of the matrix correspond to weights given to the pixels around a central pixel, z, in blurring the image. The central coefficient corresponds to the central pixel, while the remaining coefficients correspond to the surrounding pixels. Each of the pixels are multiplied by its corresponding coefficient and then summed to give H(z). In this manner, the pixels surrounding a central pixel contribute to the appearance of the central pixel in this particular picture-smoothing architecture.

Having a filter that approximates the picture-smoothing algorithm, an inverse frequency transformation may then be utilized to derive an inverse filter for the algorithm. For a twenty-five tap inverse filter of the above SmoothPicture™ filter, the resulting coefficients would be as follows.

$${H}^{- 1} ( z ) = [ \begin{matrix}- 0.0078 & 0.0149 & 0.0048 & 0.0149 & - 0.0078 \\ 0.0149 & 0.0569 & - 0.3451 & 0.0569 & 0.0149 \\ 0.0048 & - 0.3451 & 2.0460 & - 0.3451 & 0.0048 \\ 0.0149 & 0.0569 & - 0.3451 & 0.0569 & 0.0149 \\ - 0.0078 & 0.0149 & 0.0048 & 0.0149 & - 0.0078\end{matrix} ]$$

Other size filters are also suitable for use in accordance with the teachings of the present invention. Furthermore, a variety of methods are available for deriving the inverse filter given a filter that approximates the picture smoothing architecture. Generally, the larger the filter, the more accurate the inverse response will be. However, larger or smaller inverse filters may be applied, depending on implementation constraints. In one embodiment, a 5×5 filter is applied according to the following the equations.

```
Let in(x,y) = input pixel(value) at coordinate x,y
Let c(i,j) = coefficient(i,j)
Let out(x,y) = output pixel(value) at coordinate x,y
Let max_lines = number of active lines in the image frame
Let max_pix = number of active pixels in a line.
Let function ftch(x,y) =
  if (x < 1) then
    x = 1
  if (y < 1) then
    y = 1
  if (y > max_lines) then
    x = max_lines
  if (x > max_pix) then
    y = max_pix
  Return (in(x,y))
End function
for y = 1 to max_lines
  for x = 1 to max_pix
    line1 = c(0,0)*ftch(x−2,y−2) + c(0,1)*ftch(x−1,y−2) +
      c(0,2)*ftch(x,y−2) + c(0,3)*ftch(x+1,y−2) + c(0,4)*ftch(x+2,y−2)
    line2 = c(1,0)*ftch(x−2,y−1) + c(1,1)*ftch(x−1,y−1) +
      c(1,2)*ftch(x,y−1) + c(1,3)*ftch(x+1,y−1) + c(1,4)*ftch(x+2,y−1)
    line3 = c(2,0)*ftch(x−2,y) + c(2,1)*ftch(x−1,y) + c(2,2)*ftch(x,y) +
      c(2,3)*ftch(x+1,y) + c(2,4)*ftch(x+2,y)
    line4 = c(3,0)*ftch(x−2,y+1) + c(3,1)*ftch(x−1,y+1) +
      c(3,2)*ftch(x,y+1) + c(3,3)*ftch(x+1,y+1) + c(3,4)*ftch(x+2,y+1)
    line5 = c(4,0)*ftch(x−2,y+2) + c(4,1)*ftch(x−1,y+2) +
      c(4,2)*ftch(x,y+2) + c(4,3)*ftch(x+1,y+2) + c(4,4)*ftch(x+2,y+2)
    out(x,y) = round(line1 + line2 + line3 + line4 + line5)
  end
end
```

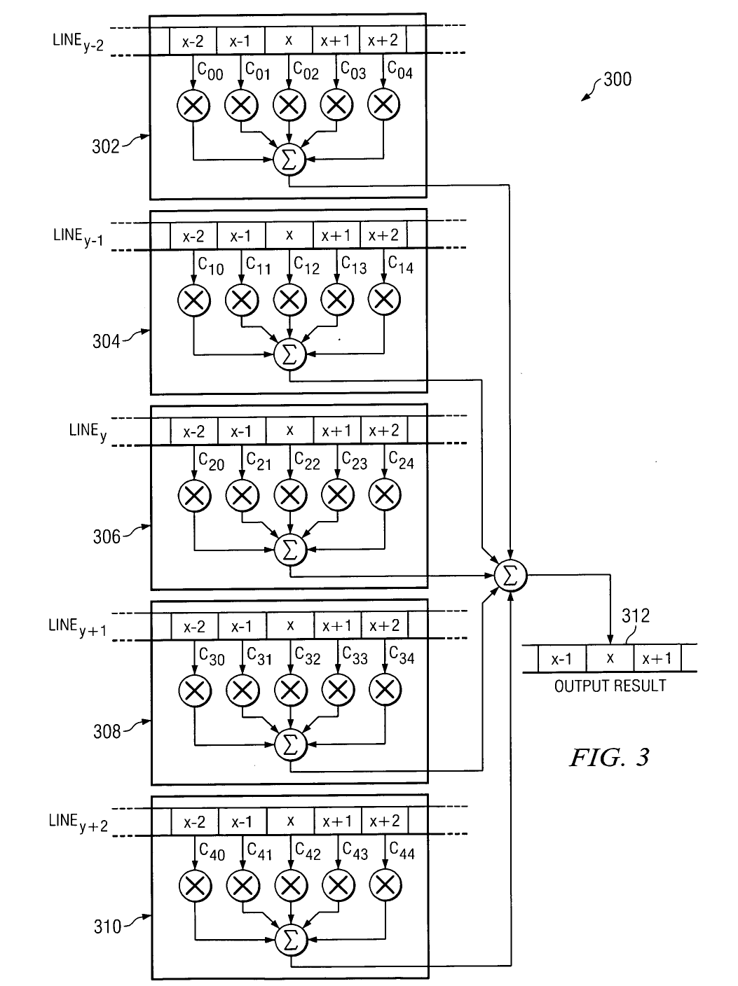

A graphical representation of the above code is illustrated in block diagram 300 in FIG. 3. In block diagram 300, the pixels extending two columns to the left and two columns to the right, and two lines above and two lines below each pixel are used to determine the output result of the filter. Blocks 302, 304, 306, 308, and 310 correspond to the calculations for lines y−2, y−1, y, y+1, and y+2, respectively. In each block, the input value of for pixels x−2, x−1, x, x+1, and x+2 are multiplied by the corresponding coefficients from the FIR filter and then summed. The results of blocks 302, 304, 306, 308 and 310 are then summed and rounded to the nearest whole integer to yield output result 312.

Referring back to FIG. 2, as mentioned previously, in particular embodiments of the present invention, the gain of the inverse filter may be adjusted based, at least in part, on the local variance of the image. In particular embodiments, this may minimize or prevent the undesirable emphasis of noise and/or mitigate ringing artifacts. To accomplish this, a local variance estimate is calculated in block 206. Generally, this estimate is calculated by taking the difference between the maximum and minimum values among the inverse filter's spatial extent. This may be performed a number of ways. In one embodiment, the calculation may be performed according to the following equations.

```
Let in(x,y) = input pixel(value) at coordinate x,y
Let var(x,y) = output variance(value) at coordinate x,y
Let max_lines = number of active lines in the image frame
Let max_pix = number of active pixels in a line
Let function ftch(x,y) =
  if (x < 1) then
    x = 1
  if (y < 1) then
    y = 1
  if (y > max_lines)
    x = max_lines
  if (x > max_pix)
    y = max_pix
  Return(in(x,y))
End function
max_val = 255.75
min_val '2 0
for y = 1 to max_lines
  for x = 1 to max_pix
    for iy = −2 to 2
      for ix = −2 to 2
        if (ftch(x + ix, y + iy) > max_val)
          max_val '2 ftch(x + ix, y + iy)
        if (ftch(x + ix, y + iy) < min_val)
          min_val = ftch(x + ix, y + iy)
      end(ix)
    end(iy)
    var(x,y) = max_val − min_val
  end(x)
end(y)
```

Once the local variance estimate is calculated, the estimate is input to a spatial gain look-up table (“LUT”) in block 208. In particular embodiments, block 208 may reduce the gain for low local variances to prevent the undesirable emphasis of noise. In particular embodiments, the gain may be reduced for high local variances. This may mitigate oscillations' near high-frequency image structures known as ringing artifacts. Because of this reduced gain for low and high local variances, block 208 depicts a bell-shaped curve for the spatial gain LUT. However, other spatial gain LUTs could be used in accordance with the teachings of the present invention, depending on the gain that is desired to be applied to the FIR filter.

In particular embodiments, the gain signal may be further multiplied by a user definable gain value in block 210. This allows the user to adjust the amount of sharpness that is applied to the image. Typically, it would be expected that this signal would be static for most viewing conditions, although the signal could be adjusted by the user through an OSD setting.

Finally, while of sharpness filter is being applied to the brightness channel of the image, delay logic is block 202 may be used to ensure that the non-brightness channels, in this example the hue and saturation channels, sync up with the brightness channel. One of ordinary skill in the art should be able to select appropriate logic to ensure that the non-brightness channels sync with the brightness channel following the application of the sharpness filter.

By applying a sharpness filter in accordance with the teachings of the present invention, particular embodiments of the present invention may increase the sharpness of an image being shown on a display device employing a picture-smoothing architecture while reducing the noise in the image and mitigating the occurrence of ringing artifacts around high frequency-image structures. Furthermore, since the sharpness filter of particular embodiments of the present invention only operates on the brightness channel of the input image, these embodiments may be implemented at a lower cost than many conventional sharpness filters that operate on more than one channel.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for increasing image sharpness in picture-smoothing architectures, comprising:
applying a finite impulse response filter to a brightness channel of an image prior to applying a picture-smoothing algorithm to the image;
determining a local variance estimate for the image;
varying a gain of the finite impulse response filter based upon the local variance estimate; and
wherein the finite impulse response filter is an inverse of a filter that approximates the picture-smoothing algorithm.

2. A method for increasing image sharpness in picture-smoothing architectures, comprising:
applying a finite impulse response filter to an image prior to applying a picture-smoothing algorithm to the image;
wherein the finite impulse response filter is an inverse of a filter that approximates the picture-smoothing algorithm.

3. The method of claim 1, wherein the finite impulse response filter is applied to a brightness channel of the image.

4. The method of claim 1, further comprising:
determining a local variance estimate for the image; and
varying a gain of the finite impulse response filter based upon the local variance estimate.

5. The method of claim 4, wherein the gain of the finite impulse response filter is reduced for low a local variance estimate.

6. The method of claim 4, wherein the gain of the finite impulse response filter is reduced for a high local variance estimate.

7. The method of claim 1, further comprising:
varying a gain of the finite impulse response filter based upon a user-definable gain value.

8. The method of claim 1, further comprising converting the image into a brightness color space prior to applying the finite impulse response filter to the image.

9. The method of claim 8, wherein the brightness color space comprises HSV.

10. The method of claim 1, further comprising converting the image out of a brightness color space after applying the finite impulse response filter to the image.

11. The method of claim 10, wherein the brightness color space comprises HSV.

12. A sharpness filter for picture-smoothing architectures, comprising:
a filter module operable to apply a finite impulse response filter to an image prior to application of a picture-smoothing algorithm to the image;
wherein the finite impulse response filter comprises an inverse of a filter that approximates the picture-smoothing algorithm.

13. The sharpness filter of claim 12, further comprising:
a local variance module operable to determine a local variance estimate for the image; and
a spatial gain module operable to adjust a gain of the finite impulse response filter based on the local variance estimate.

14. The sharpness filter of claim 13, wherein the gain of the finite impulse response filter is reduced for a low local variance estimate.

15. The sharpness filter of claim 13, wherein the gain of the finite impulse response filter is reduced for a high local variance estimate.

16. The sharpness filter of claim 12, wherein the sharpness filter operates on a brightness channel of the image.

17. The sharpness filter of claim 16, further comprising:
an input conversion module operable to convert the image from a non-brightness color space to a brightness color space prior application of the finite impulse response filter.

18. The sharpness filter of claim 17, wherein the brightness color space comprises HSV.

19. The sharpness filter of claim 16, further comprising:
an output conversion module operable to convert the image from a brightness color space to a non-brightness color space after application of the finite impulse response filter.

20. The sharpness filter of claim 19, wherein the brightness color space comprises HSV.
